(19) United States
(12) Patent Application Publication
(10) Pub. No.: US 2014/0030206 A1
(43) Pub. Date: Jan. 30, 2014

(54) Silicone Polymers

(71) Applicant: The Procter & Gamble Company, Cincinnati, OH (US)

(72) Inventors: Steven Daryl SMITH, Fairfield, OH (US); Robert Joseph McCHAIN, Cincinnati, OH (US)

(73) Assignee: The Procter & Gamble Company, Cincinnati, OH (US)

(21) Appl. No.: 13/953,520

(22) Filed: Jul. 29, 2013

Related U.S. Application Data
(60) Provisional application No. 61/676,744, filed on Jul. 27, 2012.
(60) Provisional application No. 61/763,066, filed on Feb. 11, 2013.

(51) Int. Cl. C08G 77/26

(52) U.S. Cl. CPC C08G 77/26
USPC 424/70.1; 556/424; 510/122; 510/276

(57) ABSTRACT

Disclosed are novel organopolysiloxane compositions that provide good deposition to the surface of fabric and hair. When incorporated in fabric treatment compositions, they provide anti-wrinkle benefit, softness, and anti-static benefit. When incorporated in hair conditioner compositions, they provide conditioning benefit and anti-static benefit.

### FIELD OF THE INVENTION

The present invention relates to novel organopolysiloxane compositions. The present invention further relates to fabric treatment and hair care compositions comprising the novel organopolysiloxanes.

### BACKGROUND OF THE INVENTION

Silicone polymers are used in various fields of industry due to their general characteristics such as ability to lower surface tension, lubricity, ability to suppress suds, ability to provide glossiness, thermal stability, chemical stability, and very low bioactivity to humans. Silicone polymers with various substituents of a wide range of molecular weight are used for fabric and hard-surface treatment products, cosmetic and toiletry products, and pharmaceutical products. Many of these products are based on solvents and carriers which have high polarity, such as water.

Silicone polymers are useful in wide variety of applications, including the conditioning of hair. Prior silicone compositions used in this application can result in hair that is difficult to comb. Improvements in the area of such silicones can be generally assessed by the silicones' ability to reduce friction of the treated substrate (e.g. hair, skin, fabric).

None of the existing art provides all of the advantages and benefits of the present invention.

### SUMMARY OF THE INVENTION

The present invention is directed to an organopolysiloxane having the formula (I):

M_{w}DₓT_{y}Q_{z} (I)

wherein:
M=[SiR₁R₂R₃O_{1/2}], [SiR₁R₂G₁O_{1/2}], [SiR₁G₁G₂O_{1/2}], [SiG₁G₂G₃O_{1/2}], or combinations thereof
D=[SiR₁R₂O_{2/2}], [SiR₁G₁O_{2/2}], [SiG₁G₂O_{2/2}] or combinations thereof
T=[SiR₁O_{3/2}], [SiG₁O_{3/2}] or combinations thereof
Q=[SiO_{4/2}]
   w=is an integer from 1 to about (2+y+2z)
   x=is an integer from about 5 to about 15,000
   y=is an integer from 0 to about 98,
   z=is an integer from 0 to about 98,
R₁, R₂ and R₃ are independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, C₁-C₃₂ alkylamino, and C₁-C₃₂ substituted alkylamino; and further, wherein:
At least one of the M, D, T incorporates at least one moiety G₁, G₂ or G₃ and
G₁, G₂, and G₃ are same or different moieties each of which has the formula (II):

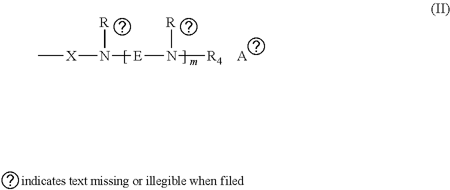

wherein:
X comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
N=a nitrogen atom;
R₄ comprises identical or different monovalent radicals from the group: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl;

E comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
m=is an integer from about 2 to about 100,
n=1 or 2
when at least one of G₁, G₂, G₃ is positively charged, A^{k-} is a suitable charge balancing anion or anions such that the total charge, k, of the charge-balancing anion or anions is equal to and opposite from the net charge on the moiety G₁, G₂ or G₃, and wherein k≦m+1 for each moiety G.

It can be appreciated by one of ordinary skill in the art that slight modifications to many of the moieties outlined above, including moieties X, E, R₁, R₂, R₃, R₄ and A, might be made.

The present invention is further directed to fabric treatment and hair care compositions comprising the organopolysiloxanes.

The present invention is still further directed to a suitable method of making the organopolysiloxanes.

These and other features, aspects, and advantages of the present invention will become evident to those skilled in the art from reading of the present disclosure.

### DETAILED DESCRIPTION OF THE INVENTION

While the specification concludes with claims particularly pointing and distinctly claiming the invention, it is believed the present invention will be better understood from the following description.

All percentages herein are by weight of the compositions unless otherwise indicated.

All ratios are weight ratios unless otherwise indicated.

All percentages, ratios, and levels of ingredients referred to herein are based on the actual amount of the ingredient by weight, and do not include solvents, fillers, or other materials with which the ingredient may be combined as commercially available products, unless otherwise indicated.

As used herein, “comprising” means that other steps and other ingredients which do not affect the end result can be added. This term encompasses the terms “consisting of” and “consisting essentially of”.

All cited references are incorporated herein by reference in their entireties. Citation of any reference is not an admission regarding any determination as to its availability as prior art to the claimed invention.

### Organopolysiloxane Composition

The organopolysiloxane of the present invention has the formula (I):

M_{w}DₓT_{y}Q_{z} (I)

wherein:
M=[SiR₁R₂R₃O_{1/2}], [SiR₁R₂G₁O_{1/2}], [SiR₁G₁G₂O_{1/2}], [SiG₁G₂G₃O_{1/2}], or combinations thereof
D=[SiR₁R₂O_{2/2}], [SiR₁G₁O_{2/2}], [SiG₁G₂O_{2/2}] or combinations thereof
T=[SiR₁O_{3/2}], [SiG₁O_{3/2}] or combinations thereof
Q=[SiO_{4/2}]
   w=is an integer from 1 to about (2+y+2z)
x=is an integer from about 5 to about 15,000
y=is an integer from 0 to about 98,
z=is an integer from 0 to about 98,
R₁, R₂ and R₃ are independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, C₁-C₃₂ alkylamino, and C₁-C₃₂ substituted alkylamino; and further, wherein:
At least one of the M, D, T incorporates at least one moiety G₁, G₂ or G₃ and
G₁, G₂, and G₃ are same or different moieties each of which has the formula (II):

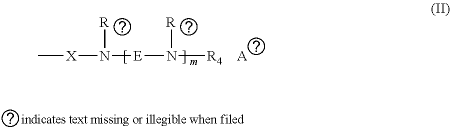

wherein:
X comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
N=a nitrogen atom;
R₄ comprises identical or different monovalent radicals from the group: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl;
E comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
m=is an integer from about 2 to about 100,
n=1 or 2
when at least one of G₁, G₂, G₃ is positively charged, A^{k-} is a suitable charge balancing anion or anions such that the total charge, k, of the charge-balancing anion or anions is equal to and opposite from the net charge on the moiety G₁, G₂ or G₃, and wherein k≦m+1 for each moiety G.
   In one embodiment, Aₖ₋ is Cl−, Br−,I−, methylsulfate, toluene sulfonate, carboxylate, phosphate or combinations thereof.

It can be appreciated by one of ordinary skill in the art that slight modifications to many of the moieties outlined above, including moieties X, E, R₁, R₂, R₃, R₄ and A, might be made.

In one embodiment, w is an integer from about 2 to about 50. In another embodiment, w is 2. Regarding x, in one embodiment, x is an integer from about 10 to about 4,000. In another embodiment, x is an integer from about 40 to about 2,000. In yet another embodiment, w is 2, x is an integer from about 20 to about 1,000, and y and z are 0.

In another embodiment, X comprises a divalent radical comprising from 2 to 12 carbon atoms, and each divalent radical is independently a —(CH₂)ₚ— group, where p is an integer from 2 to 12.

In one embodiment, E represents different radicals. In another embodiment, at least one E radical is an ethylene radical. In yet another embodiment, at least one E radical comprises more than 3 carbon atoms. Regarding R₄, in one embodiment, R₄ are different radicals. In another embodiment, at least one R₄ is a methyl radical.

In one embodiment, for at least one G₁, G₂ or G₃, m is an integer from 2 to about 50. In another embodiment, for at least one G₁, G₂ or G₃, m is an integer from 2 to about 25. In yet another embodiment, for at least one G₁, G₂ or G₃, m is an integer from 2 to about 10.

In one embodiment, for at least one G₁, G₂ or G₃, k is an integer from 0 to about 201. In another embodiment, for at least one G₁, G₂ or G₃, k is an integer from 2 to about 50.

In one embodiment, the organopolysiloxanes of the present invention are charge-functionalized.

### Methods of Making the Organopolysiloxane

Embodiments of the present invention can be made using these general methods: An amount of amino silicone is added to a clean vessel under inert atmosphere. Optionally, a solvent such as isopropanol or tetrahydrofuran is added. The reaction is optionally mixed and quantities of diamine and dihalide are added either simultaneously or, optionally, the diamine is added first and the dihalide second, to obtain the targeted compositions. may be run at room temperature or may be heated. It can be appreciated by one of ordinary skill in the art that other difunctional organic species capable of reacting with the nitrogen moieties of the diamines might be useful in the scope of the current invention.

The reaction is run at a temperature appropriate for the reagents. For example, when dichlorides are used as the dihalide are run at higher temperatures (typically above 60° C. and often above 80° C.). Alternately, when dibromides are used as the dihalide, the reaction A method of manufacturing the organopolysiloxane of the present invention comprises combining amino silicone, diamine and dihalide under inert atmosphere and reacting at a temperature from about ambient to about 80° C. In another embodiment, the method further comprises adding a solvent to the amino silicone prior to combining the amino silicone with the diamine and dihalide.

### Methods of Making Compositions Comprising the Organopolysiloxane

The organopolysiloxane polymers of the present invention may be mixed with surfactants and solvents to prepare emulsions.

Examples of surfactants & solvents which may be successfully used to create such emulsion include: secondary alcohol ethoxylates like Tergitol 15-S-5, Terigtol 15-S-12, and TMN-10. The suspensions can be made by mixing the components together using a variety of mixing devices. Examples of suitable overhead mixers include: IKA Labortechnik, and Janke & Kunkel IKA WERK, equipped with impeller blade Divtech Equipment R1342. In some cases, high shear processing is required to obtain a narrow particle size distribution. Example of a suitable high shear processing device is M-110P Microfluidizer from Microfluidics.

### Uses of the Organopolysiloxane Compositions

The organopolysiloxanes according to the present invention can be incorporated in a variety of compositions. These compositions include both aqueous and non-aqueous compositions. The compositions for treating fabric, paper, non-wovens, hair, body and hard surfaces. In one embodiment, the composition comprising an organopolysiloxane is non-aqueous. In another embodiment, the composition is aqueous.

In one embodiment, the aqueous composition has a pH greater than 3. In another embodiment, the aqueous composition has a pH greater than 5.

The organopolysiloxane can be applied to a variety of substrates. Embodiments of substrates include fabric, non-woven materials, paper products, hard surface materials and biological material. In one embodiment, the biological material comprises keratin, such as hair or skin.

In one embodiment, the composition also comprises one or more cleansing agents. The cleansing agents may comprise anionic, non-ionic, and/or cationic surfactants. In one embodiment, at least one cleansing agent is a detersive cleansing agent.

The composition may also comprise at least one benefit agent. In one embodiment, the benefit agent is a liquid at room temperature. In another embodiment, the benefit agent is a solid or semi-solid at room temperature. The benefit agent may be encapsulated. In one embodiment, the encapsulated benefit agent is a perfume. In one embodiment, the benefit agent is a silicone. In another embodiment, the benefit agent is a perfume.

The benefit agent and the organopolysiloxane may be pre-mixed prior to compounding into a composition. In one embodiment, the benefit agent and the organopolysiloxane comprise a particle.

In one embodiment, the composition also comprises one or more cleansing agents. The cleansing agents may comprise anionic, non-ionic, and/or cationic surfactants. In one embodiment, at least one cleansing agent is a detersive cleansing agent.

The composition may also comprise at least one benefit agent. In one embodiment, the benefit agent is a liquid at room temperature. In another embodiment, the benefit agent is a solid or semi-solid at room temperature. The benefit agent may be encapsulated. In one embodiment, the encapsulated benefit agent is a perfume. In one embodiment, the benefit agent is a silicone. In another embodiment, the benefit agent is a perfume.

In one embodiment, the benefit agent is hydrophobic. In another embodiment, the benefit agent is hydrophilic. Useful hydrophobic benefit agents include silicones, vinyl polymers, polyethers, materials comprising a hydrocarbon wax, hydrocarbon liquids, fluid sugar polyesters, fluid sugar polyethers, and mixtures thereof. In one embodiment, the silicones that are useful as benefit agents are organosilicones. In another embodiment, the silicone benefit agent is selected from the group consisting of a polydimethylsiloxane, an aminosilicone, a cationic silicone, a silicone polyether, a cyclic silicone, a silicone resin, a fluorinated silicone and mixtures thereof.

In one embodiment, the vinyl polymer benefit agent is selected from group consisting of
(i) hydrogenated or unhydrogenated polyisoprene;
(ii) hydrogenated or unhydrogenated polyisoprene comprising one or more monomers selected from the group consisting of styrene, acrylonitrile, and acrylates;
(iii) hydrogenated or unhydrogenated polyisobutylene;
(iv) hydrogenated or unhydrogenated polyisobutylene comprising one or more monomers selected from the group consisting of styrene, acrylonitrile, and acrylates;
(v) hydrogenated or unhydrogenated polybutadiene;
(vi) hydrogenated or unhydrogenated polybutadiene comprising one or more monomers selected from the group consisting of styrene, acrylonitrile, and acrylates;
(vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
(viii) acrylate polymer;
(ix) methacrylate polymer; and
(x) acrylate copolymers comprising at least two or at least three different acrylate and/or methacrylate monomers.

In another embodiment, the vinyl polymer benefit agent comprises a material selected from the group consisting of isoprene-isobutylene copolymer, carboxylated acrylonitrile butadiene copolymer, styrene-isoprene copolymer,styrene-butadiene block copolymers, and mixtures thereof.

In one embodiment, the polyether benefit agent comprises a material selected from the group consisting of ethylene oxide, propylene oxide, butylene oxide and mixtures thereof. In another embodiment, the polyether benefit agent comprises a material selected from the group consisting of polyethylene oxide, polypropylene oxide, poly alkyl oxirane, and mixtures thereof. In another embodiment, the hydrocarbon wax benefit agent comprises a material selected from the group consisting of a hydrocarbon liquid, silicone, and mixtures thereof. In yet another embodiment, the hydrocarbon liquid benefit agent comprises one or more C5 to C100 alkanes. In another embodiment, the hydrocarbon wax benefit agent comprises a material selected from petrolatum, microcrystalline wax, paraffin wax, Beeswax, Chinese wax, Lanolin, Spermaceti, Bayberry wax, Myrica faya, Candelilla wax, Carnauba wax, Copernica cerifera, Castor wax, Esparto wax, Japan wax, Jojoba oil, Simmondsia chinensis, Ouricury wax, Syagrus coronata. Rice bran wax, Soy wax, Ceresin waxes, Montan wax, Ozocerite, Peat waxes, Polyethylene waxes, Fischer-Tropsch waxes, amide substituted waxes, polymerized α-olefins, and mixtures thereof. In another embodiment, the hydrocarbon liquid comprises a material selected from the group consisting of mineral oil, non-crystalline polymerized a-olefins, and mixtures thereof.

In one embodiment, the fluid sugar polyester benefit agent comprises a cyclic polyol and/or reduced saccharide. In another embodiment, from about 33 to about 100% of the cyclic polyol' s and/or reduced saccharide's hydroxyl moieties are esterified. In another embodiment, two or more of the ester moieties are independently attached to an alkyl or an alkenyl chain. In another embodiment, the alkyl or alkenyl chain can be derived from a fatty acid mixture comprising at least 50% by weight of the mixture tallow fatty acid and/or oleyl fatty acid. In another embodiment, the fatty acid mixture comprises a mixture of tallow fatty acid and oleyl fatty acid in a weight ratio of tallow fatty acid: oleyl fatty acid of 10:90 to 90:10, or 25:75 to 75:25. In another embodiment, the fatty acid mixture contains only tallow fatty acid and oleyl fatty acid.

In one embodiment, the fluid sugar polyether benefit agent comprises a cyclic polyol and/or reduced saccharide. In another embodiment, from about 33 to about 100% of the cyclic polyol' s and/or reduced saccharide's hydroxyl moieties are etherified. In another embodiment, two or more of the ether moieties are independently attached to an alkyl or an alkenyl chain. In another embodiment, the alkyl or alkenyl chain can be derived from a fatty alcohol mixture comprising at least 50% by weight of the mixture tallow fatty alcohol and/or oleyl fatty alcohol. In another embodiment, the fatty alcohol mixture comprises a mixture of tallow fatty alcohol and oleyl fatty alcohol in a weight ratio of tallow fatty acid: oleyl fatty alcohol of 10:90 to 90:10, or 25:75 to 75:25. In another embodiment, the fatty alcohol mixture contains only tallow fatty alcohol and oleyl fatty alcohol.

In one embodiment, the silicone benefit agent has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons. In another embodiment, the vinyl polymer benefit agent has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons. In another embodiment, the polyether benefit agent has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons.

In one embodiment, the polydimethyl siloxane has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise.

In another embodiment, the aminosilicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise. In another embodiment, the cationic silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise. In another embodiment, the silicone polyether has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise. In another embodiment, the cyclic silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise. In another embodiment, the silicone resin has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise. In another embodiment, fluorinated silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise.

In one embodiment, the hydrophobic benefit agent and the organopolysiloxane comprise a particle. In another embodiment, the hydrophobic benefit agent comprises the core of the particle and the organopolysiloxane is generally disposed on the surface of the particle.

In one embodiment, the calculated free energy of dissolution of the organopolysiloxane in the hydrophobic benefit agent and the calculated free energy of dissolution of the organopolysiloxane in the aqueous portion of the aqueous composition are both greater than the calculated free energy of the organopolysiloxane at the interface of the hydrophobic benefit agent and the aqueous portion of the aqueous composition. In another embodiment, the calculated free energy of dissolution of the organopolysiloxane in the hydrophobic benefit agent and the calculated free energy of dissolution of the organopolysiloxane in the aqueous portion of the aqueous composition are both more than 50 KJ/mol greater than the calculated free energy of the organopolysiloxane at the interface of the hydrophobic benefit agent with the aqueous portion of the aqueous composition.

### EXAMPLES

The following examples further describe and demonstrate the preferred embodiments within the scope of the present invention. The examples are given solely for the purpose of illustration and are not to be construed as limitations of the present invention since many variations thereof are possible without departing from the spirit and scope of the invention. Ingredients are identified by chemical name, or otherwise defined below.

Prior to assessing the compositions comprising the organopolysiloxane in the technical methods herein, it is important that each test sample suspension has a volume-weighted, mode particle size of <1,000 nm and preferably >200 nm, as measured >12 hrs after emulsification, and <12 hrs prior to its use in the testing protocol. Particle size distribution is measured using a static laser diffraction instrument, operated in accordance with the manufactures instructions. Examples of suitable particle sizing instruments include: Horiba Laser Scattering Particle Size and Distributer Analyzer LA-930 and Malvern Mastersizer.

### Examples 1-24

### Organopolysiloxane Compositions

Organopolysiloxanes of the present invention are prepared as follows:

### Experimental

To a clean vessel under inert atmosphere is added an amount of amino silicone. Optionally, a solvent such as isopropanol or tetrahydrofuran is added. The reaction is optionally mixed and quantities of diamine and dihalide are added either simultaneously or optionally the diamine is added first and the dihalide second, to obtain the targeted compositions. The reaction is run at a temperature appropriate for the reagents. Dichlorides are run at higher temperatures (typically above 60° C. and often above 80° C.). Dibromides may be run at room temperature or may be heated.

### Examples 1-15

### Synthesis from Dibromo Compounds

Each sample is prepared as follows:

To a clean vessel is added the quantity of silicones (available from Gelest Co., Morrisville, Pa.) shown in Table 1 and the quantity of diamine (available from Sigma-Aldrich, Milwaukee, Wis.) shown and an amount of isopropanol (available from, Sigma-Aldrich, Milwaukee, Wis.) equal to the amount of silicone. This is mixed by stirring the sample at 30 rpm for one hour and then the quantity of dibromide (available from Sigma-Aldrich, Milwaukee, Wis.) is added and mixed by stirring at 30 rpm for 2 hours at 25° C. This is followed by heating the sample at 50° C. for 16 hours.

### Examples 16-17

### Synthesis from Dichloro Compounds

To a clean vessel is added the quantity of silicones (available from Gelest Co., Morrisville, Pa.) shown in Table 1 and the quantity of diamine (available from Sigma-Aldrich, Milwaukee, Wis.) shown. This is mixed by stirring the sample at 30 rpm for one hour and then the quantity of dichlorlide (available from Sigma-Aldrich, Milwaukee, Wis.) is added and mixed by stirring at 30 rpm for 2 hours at 25° C. This is followed by heating the sample at 85° C. for 72 hours.

The samples in Table 1 are prepared according using the amounts shown.

TABLE 1
Synthesis of the organopolysiloxane from dihalides

| | | | | | | | | | Average # Repeat |
|---|---|---|---|---|---|---|---|---|---|
| | | Amino Silicone | | | | | | | Units of polyquat |
| Ex. | Sample ID | starting meterial¹ | wt Silicone | Silicone MW | Wt Dihalide | Dihalide | Wt Diamine | Diamine² | on each end (=m/2) |
| 1 | PA2- | DMS- | 75 g | 3000 | 12.20 g | Dibromo | 8.60 g | TMHDA | 1 |
| | DMSA1 | A15 | | | | hexane | | | |
| | 5-PA2 | | | | | | | | |
| 2 | PA5- | DMS- | 50 g | 3000 | 20.33 g | Dibromo | 14.33 g | TMHDA | 2 |
| | DMSA1 | A15 | | | | hexane | | | |
| | 5-PA5 | | | | | | | | |
| 3 | PA10- | DMS- | 25 g | 3000 | 20.33 g | Dibromo | 14.33 g | TMHDA | 5 |
| | DMSA1 | A15 | | | | hexane | | | |
| | 5-PA10 | | | | | | | | |
| 4 | PA20- | DMS- | 25 g | 3000 | 40.67 g | Dibromo | 28.67 g | TMHDA | 10 |
| | DMSA1 | A15 | | | | hexane | | | |
| | 5-PA20 | | | | | | | | |
| 5 | PA0.5- | DMS- | 500 g | 30000 | 2.03 g | Dibromo | 1.43 g | TMHDA | 0.5 |
| | DMSA3 | A32 | | | | hexane | | | |
| | 2-PA0.5 | | | | | | | | |
| 6 | PA1- | DMS- | 500 g | 30000 | 4.07 g | Dibromo | 2.87 g | TMHDA | 1 |
| | DMSA3 | A32 | | | | hexane | | | |
| | 2-PA1 | | | | | | | | |
| 7 | PA2- | DMS- | 250 g | 30000 | 4.07 g | Dibromo | 2.87 g | TMHDA | 2 |
| | DMSA3 | A32 | | | | hexane | | | |
| | 2-PA2 | | | | | | | | |
| 8 | PAS- | DMS- | 100 g | 30000 | 4.07 g | Dibromo | 2.87 g | TMHDA | 5 |
| | DMSA3 | A32 | | | | hexane | | | |
| | 2-PA5 | | | | | | | | |
| 9 | PA10- | DMS- | 1000 g | 30000 | 81.33 g | Dibromo | 57.33 g | TMHDA | 10 |
| | DMSA3 | A32 | | | | hexane | | | |
| | 2-PA10 | | | | | | | | |
| 10 | PA20- | DMS- | 100 g | 30000 | 16.27 g | Dibromo | 11.47 g | TMHDA | 20 |
| | DMSA3 | A32 | | | | hexane | | | |
| | 2-PA20 | | | | | | | | |
| 11 | PA2- | DMS- | 150 g | 50000 | 1.46 g | Dibromo | 1.03 g | TMHDA | 2 |
| | DMSA3 | A35 | | | | hexane | | | |
| | 5-PA2 | | | | | | | | |
| 12 | PA5- | DMS- | 150 g | 50000 | 3.66 g | Dibromo | 2.58 g | TMHDA | 5 |
| | DMSA3 | A35 | | | | hexane | | | |
| | 5-PA5 | | | | | | | | |
| 13 | PA10- | DMS- | 200 g | 50000 | 9.76 g | Dibromo | 6.88 g | TMHDA | 10 |
| | DMSA3 | A35 | | | | hexane | | | |
| | 5-PA10 | | | | | | | | |
| 14 | PA2- | DMS- | 500 g | 30000 | 10.93 g | Dibromo- | 3.87 g | TMEDA | 2 |
| | DMSA3 | A32 | | | | dodecane | | | |
| | 2-PA2 | | | | | | | | |
| 15 | PA2- | DMS- | 250 g | 30000 | 3.60 g | Dibromo | 1.93 g | TMEDA | 2 |
| | DMSA3 | A32 | | | | butane | | | |
| | 2-PA2 | | | | | | | | |
| 16 | PA20- | DMS- | 100 g | 30000 | 10.33 g | Dichloro | 11.47 g | TMHDA | 20 |
| | DMSA1 | A32 | | | | hexane | | | |
| | 5-PA20 | | | | | | | | |
| 17 | PA1- | DMS- | 100 g | 30000 | 0.52 g | Dichloro | 0.57 g | TMHDA | 5 |
| | DMSA3 | A32 | | | | hexane | | | |
| | 2-PA1 | | | | | | | | |

¹All silicone starting materials available from Gelest Co., Morrisville, PA. DMS-A15 = Terminal bis-aminopropylpolydimethylsiloxane with 3,000 Da molecular weight, DMS-A32 = Terminal bis-aminopropylpolydimethylsiloxane with 30,000 Da molecular weight, DMS-A35 = Terminal bis-aminopropylpolydimethylsiloxane with 50,000 Da molecular weight
²TMHDA = tetramethyl-hexane-diamine, TMEDA = tetramethyl-ethane-diamine

Further non-limiting examples of synthesis of the organopolysiloxane of the present invention are given as examples 18-24.

### Example 18

### Terminal Chloro Functional Silicone Preparation

To a clean vessel is added 200 grams of terminal amino functional silicone (DMS-A32, as above, available from Gelest Co., Morrisville, Pa.), 200 grams of anhydrous tertahydrofuran (available from Sigma-Aldrich, Milwaukee, Wis.) and 3 g chloro-acetyl chloride (available from Sigma-Aldrich, Milwaukee, Wis.) and 2 grams of triethylamine (available from, Sigma-Aldrich, Milwaukee, Wis.). This is mixed by stirring the sample at 30 rpm for two hours and then the reaction is terminated by addition of water and extracted with 0.1 N Hydrochloric acid, three times, followed by two extractions with 0.1 N sodium hydroxide, followed by one extraction with deionized water. The sample is vacuum dried at 50° C. for 16 hours.

### Example 19

100 grams of chlorofunctional silicone prepared in example 18 is added to a flask along with 12.61 grams of tetramethylhexanediamine (available from Sigma-Aldrich, Milwaukee, Wis.) and 10.33 grams of dichlorohexane (available from Sigma-Aldrich, Milwaukee, Wis.). This is stirred and heated to 90° C. for 72 hours.

### Example 20

100 grams of terminal chlorofunctional silicone (DMS-L21³ available from Gelest Co., Morrisville, Pa.) is added to a flask along with 24.08 grams of tetramethylhexanediamine (available from Sigma-Aldrich, Milwaukee, Wis.) and 15.50 grams of dichlorohexane (available from Sigma-Aldrich, Milwaukee, Wis.). This is stirred and heated to 90° C. for 72 hours. ³DMS-L21=Terminal bis-chloromethylpolydimethylsiloxane with 7,000 Da molecular weight

### Example 21

100 grams of terminal epoxy functional silicone (5K)(DMS-E21⁴ available from Gelest Co., Morrisville, Pa.) is reacted with 20.23 grams of butanediol-diglycidyl ether (available from Sigma-Aldrich, Milwaukee, Wis.) and 12.04 grams of piperazine (available from Sigma-Aldrich, Milwaukee, Wis.). The reaction is stirred at room temperature for 4 hours and then precipitated into 100 grams of water. ⁴DMS-E21=Terminal bis-epoxypropoxypropylpolydimethylsiloxane with 5,000 Da molecular weight

### Example 22

100 grams of terminal amine functional silicone (30K)(DMS-A32, as above, available from Gelest Co., Morrisville, Pa.) is reacted with 13.48 grams of butanediol-diglycidyl ether (available from Sigma-Aldrich, Milwaukee, Wis.) and 5.73 grams of piperazine (available from Sigma-Aldrich, Milwaukee, Wis.). The reaction is stirred at room temperature for 4 hours and then precipitated into 100 grams of water.

### Example 23

100 grams of terminal epoxy functional silicone (30K) is reacted with 6.17 grams of epichlorohydrin (available from Sigma-Aldrich, Milwaukee, Wis.) and 6.31 grams of piperazine (available from Sigma-Aldrich, Milwaukee, Wis.). The reaction is stirred at room temperature for 4 hours and then precipitated into grams of water.

### Example 24

100 grams of terminal amine functional silicone (30K)(DMS-A32, as above, available from Gelest Co., Morrisville, Pa.) is reacted with 6.17 grams of epichlorohydrin (available from Sigma-Aldrich, Milwaukee, Wis.) and 5.73 grams of piperazine (available from Sigma-Aldrich, Milwaukee, Wis.). The reaction is stirred at room temperature for 4 hours and then precipitated into grams of water.

### End-Use Formulations:

Quaternized silicones with the structures shown below were formulated into different chassis to collect friction data on hair, top sheets, and fabrics. It would be known by one of ordinary skill in the art that the structure of formula (III) and nomenclature of the quaternized silicones in Table 2 is generally a subset of the organopolysiloxanes and can be depicted by the M_{w}DₓT_{y}Q_{z} nomenclature above.

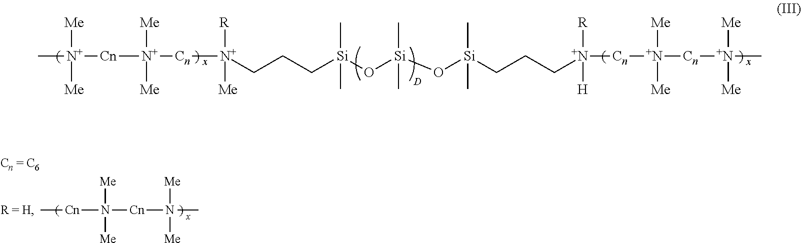

TABLE 2
Quaternized silicone examples per formula (III)

| | | Amino | | # of | | |
|---|---|---|---|---|---|---|
| Example | Sample Name | Silicone | D | nitrogen* | Cₙ | X |
| 25 | PA2-DMSA31-PA2 | DMS-A31 | 335 | 10 | C₆ | 2 |
| 26 | PA5-DMSA31-PA5 | DMS-A31 | 335 | 22 | C₆ | 5 |
| 27 | PA10-DMSA31- | DMS-A31 | 335 | 42 | C₆ | 10 |
| | PA10 | | | | | |
| 28 | PA20-DMSA31- | DMS-A31 | 335 | 82 | C₆ | 20 |
| | PA20 | | | | | |
| 29 | PA2-DMSA32-PA2 | DMS-A32 | 402 | 10 | C₆ | 2 |
| 30 | PA5-DMSA32-PA5 | DMS-A32 | 402 | 22 | C₆ | 5 |
| 31 | PA10-DMSA32- | DMS-A32 | 402 | 42 | C₆ | 10 |
| | PA10 | | | | | |
| 32 | PA20-DMSA32- | DMS-A32 | 402 | 82 | C₆ | 20 |
| | PA20 | | | | | |
| 33 | PA2-DMSA35-PA2 | DMS-A35 | 672 | 10 | C₆ | 2 |
| 34 | PA5-DMSA35-PA5 | DMS-A35 | 672 | 22 | C₆ | 5 |
| 35 | PA10-DMSA35- | DMS-A35 | 672 | 42 | C₆ | 10 |
| | PA10 | | | | | |
| 36 | PA20-DMSA35- | DMS-A35 | 672 | 82 | C₆ | 20 |
| | PA20 | | | | | |

*Assuming R═H

Table 3 depicts the examples of Table 2 in M_{w}DₓT_{y}Q format.

TABLE 3
Quaternized silicone of Table 2 depicted as M_{w}DₓT_{y}Q_{z}

| Example | X | E | m |
|---|---|---|---|
| 25 | 335 | Hexylenyl | 4 |
| 26 | 335 | Hexylenyl | 10 |
| 27 | 335 | Hexylenyl | 20 |
| 28 | 335 | Hexylenyl | 40 |
| 29 | 402 | Hexylenyl | 4 |
| 30 | 402 | Hexylenyl | 10 |
| 31 | 402 | Hexylenyl | 20 |
| 32 | 402 | Hexylenyl | 40 |
| 33 | 672 | Hexylenyl | 4 |
| 34 | 672 | Hexylenyl | 10 |
| 35 | 672 | Hexylenyl | 20 |
| 36 | 672 | Hexylenyl | 40 |

For the M_{w}DₓT_{y}Q_{z} depictions of Examples 25-36; M=[SiR₁R₂G₁O_{1/2}], w=2, D=[SiR₁R₂O_{2/2}], T=Q=not included, y=z=0, R₁=R₂=methyl, X=propeneyl, R₄=combination of H, methyl, n=combination of 1, 2.

### Pre-Emulsions of the Organopolysiloxanes

The materials prepared as Examples 25-36 were emulsified using the following recipe to obtain 20% active silicone emulsions for testing:

| Step | Material | % active |
|---|---|---|
| 1 | Polyquat DMS-A32 | 20.00% |
| 2 | Tergitol 15-S-5 ¹ | 3.00% |
| 3 | Acetic Acid | 0.60% |
| 4 | Dilution Water 1 | 10.00% |
| 5 | Dilution Water 2 | 77.90% |

¹ Polyglycol ether (nonionic) surfactant available from Sigma Aldrich

Molecules were first pre-emulsified using a homogenizer at 3,500 rpm and then microfluidized at 20,000 psi to obtain sub-micron size emulsions (mean particle size 250 nm by Horriba). It would be understood by one of ordinary skill in the art that the stepwise addition of water would indicate that the first dilution water was used to homogenize the composition at 3,500 rpm and that the second dilution water was used to microfluidize the composition ay 20,000 psi.

### Hair Care Compositions Comprising the Organopolysiloxanes

Shampoos were prepared as follows:

| Material | % active in shampoo |
|---|---|
| Deionized Water | 80.26% |
| SLE1S ¹ | 10.50% |
| CMEA ² | 0.85% |
| Na₄EDTA | 0.14% |
| NaBenzoate | 0.25% |
| Citric acid | 0.22% |
| SLS ³ | 1.50% |
| CAPB ⁴ | 1.00% |
| Kathon | 0.03% |
| 20% Silicone Emulsion ⁵ | 5.00% |
| C500 Guar ⁶ | 0.25% |

¹ Sodium Laureth Sulfate, 28% active, supplier: P&G
² Cocoamide MEA available as Monamid CMA, 85% active, available from Goldschmidt Chemical
³ Sodium Lauryl Sulfate, 29% active from P&G
⁴ Cocoamidopropyl Betaine available as Tego ® betaine F-B, 30% active, available from Goldschmidt Chemicals
⁵ Pre-emulsion comprising the organopolysiloxane as described herein
⁶ Jaguar ® C500, MW - 500,000, CD = 0.7, available from Rhodia

Ingredients were combined and mixed by conventional means as known by one of ordinary skill in the art.

Hair Conditioners were prepared as follows:

| Material | % active in conditioner |
|---|---|
| Cetyl Alcohol | 1.21% |
| Stearyl Alcohol | 3.00% |
| Behentrimonium methosulfate/IPA ¹ | 2.47% |
| Benzyl Alcohol | 0.43% |
| Deionized Water | 87.15% |
| Perfume | 0.59% |
| EDTA | 0.15% |
| 20% silicone emulsion ² | 5.00% |

¹ Behentrimonium methosulfate/Isopropyl alcohol, available as Genamin BTMS from Clariant
² Pre-emulsion comprising the organopolysiloxane as described herein

Ingredients were combined and mixed by conventional means as known by one of ordinary skill in the art.

### Hair Treatments

The MEL-II Brush protocol was used to treat the hair with shampoos. In this automated treatment process, the shampoo formulation is added to pre-wetted hair switches manually. The shampoo is applied in a zig-zag form at 0.05 g of product/g of hair. A set of brushes will spread the product to the entire hair by brushing up and down for 30 seconds followed by a brush rinse for an additional 30 seconds. The rinse water is run at 6.5 gallons per minute at a temperature of 100° F. This process was repeated 3 times to complete a 3 cycle treatment. A separate rinsing process is followed after completing the 3 cycle treatment using an automated rinse tester (ART). During this process, hair switches are rinsed using city tap water sprayed through two nozzles at a flow rate between 200 to 500 ml/min. A clamping device compressed the hair switches between two pads that squeeze the water out while sliding down the hair switch. After sliding the pad down the hair 21 times (21 strokes), the hair switch is removed and let air dry in a humidity controlled room.

The treatment process in conditioners is done by a milking process. First, a 20 g hair switch is system treated with 1 mL of shampoo (0.05 g of shampoo/ g of hair). The switch is lathered with milking motion for 30 secs and rinsed 15 seconds on each side. The shampoo application and lathering is repeated, ending with a 120 second rinse (60 secs on each side). The shampoo used in this system test was Pantene Medium-Thick Frizzy to Smooth. After the shampoo application, 2.0 mL of conditioner is applied followed by a 30 second rinse. Finally, the switch is squeezed, pat-towel-dried, combed and hung to dry in 21° C./45% RH room for at least 18 hours.

### Friction Testing

In shampoos, the hair feel was measured using an inter-fiber friction (IFF) test that measures the hair to hair interaction (resistance/friction) while applying a constant pressure of 1400 gf to a hair switch, sandwiched between artificial skin surrogates. The instrument uses a probe that when pressurized, pinches the hair against a flat surface then cycles up and down for five complete strokes. Both sides of the switch are to be evaluated to determine the consistency of the treatment. Data from the evaluation is analyzed using an Excel adding macro which condenses the data to Area Sum and Peak Sum that is used to rank order products.

In conditioners, an instron friction measurement (IFM) was used to evaluate the dry hair smoothness. Dried hair is clipped on the right side of the friction table and combed with narrow teeth side of comb 2 times to have good hair alignment. A 200 g sled-weight is put on the middle of the hair switch and slide down without disrupting the hair alignment. The bottom of the sled is prepared by attaching a piece of polyurethane that exactly fits the bottom of the sled including edges. Measurement is performed five times per treatment and the force to slide the 200 g sled is recorded and average.

### Test Results

In testing the shampoo compositions described above, Pantene smooth and sleek and Jade SS were used as controls in the test. Pantene smooth and sleek is a 2-in-1 cosmetic shampoo with 1.35% PDMS and Jade SS is a Gel Network Shampoo with 2% PDMS. (Stnd. Dev.=Standard Deviation)

| Organopolysiloxane | Average Peak Sum | Stnd. |
|---|---|---|
| Sample Name | Friction (gF) | Dev. |
| PA2-DMSA35-PA2 | 1197.200 | 97.131 |
| PA10-DMSA35-PA10 | 1355.313 | 57.243 |
| PA10-DMSA32-PA10 | 1386.523 | 80.309 |
| PA5-DMSA32-PA5 | 1451.519 | 64.163 |
| PA2-DMSA32-PA2 | 1490.359 | 97.114 |
| Jade SS | 1542.607 | 79.756 |
| PA5-DMSA35-PA5 | 1547.724 | 55.063 |
| Smooth and Sleek Shampoo (AP) | 1957.520 | 124.794 |

In testing the hair conditioner compositions described above, MF100, M10P1, and a 16,000 cst terminal amino silicone (TAS) were used as controls in the test. M10P1 is a conditioner with a 4.2% blend of 18MMcst PDMS gum with D5 at 85/15 ratio. MF100 is a conditioner with a 10% blend of 18MMcst PDMS gum with 200cst at 85/15 ratio.

| Organopolysiloxane | | Stnd. |
|---|---|---|
| Sample Name | Friction (gF) | Dev. |
| PA2-DMSA31-PA2 emulsion | 85.644 | 0.664 |
| PA10-DMSA31-PA10 emulsion | 86.032 | 3.203 |
| PA20-DMSA31-PA20 emulsion | 89.954 | 3.559 |
| PA5-DMSA31-PA5 emulsion | 92.231 | 5.244 |
| MF100 | 96.526 | 3.825 |
| Y14945 TAS | 119.228 | 2.973 |
| M10P1 | 140.441 | 3.666 |
| PA20-DMSA32-PA20 emulsion | 77.926 | 3.833 |
| PA2-DMSA32-PA2 emulsion | 80.003 | 0.348 |
| PA10-DMSA32-PA10 emulsion | 80.026 | 3.113 |
| PA5-DMSA32-PA5 emulsion | 83.833 | 5.016 |
| MF100 | 107.364 | 0.502 |
| Y14945 TAS | 122.356 | 0.402 |
| M10P1 | 158.840 | 6.104 |
| PA10-DMSA35-PA10 emulsion | 93.095 | 7.575 |
| PA5-DMSA35-PA5 emulsion | 95.143 | 4.595 |
| MF100 | 101.769 | 0.897 |
| PA5-DMSA32-PA5 emulsion | 107.424 | 4.348 |
| PA20-DMSA35-PA20 emulsion | 108.893 | 2.745 |
| Y14945 TAS | 130.597 | 1.931 |
| PA2-DMSA32-PA2 emulsion | 142.309 | 4.009 |
| M10P1 | 151.406 | 5.069 |

### Top Sheets and Paper

Softening benefits of these organopolysiloxane molecules on substrates (top sheets and paper) were evaluated using the IFM method that was used in the assessment of hair conditioners (above). A pre-emulsion of the PA5-DMSA32-PA5 sample was prepared as described above was air sprayed onto a 24 gsm (gsm=grams per square meter) non-woven top sheet to obtain a final coating of 5 gsm. Top sheets were air dried over night and let to equilibrate in a controlled humidity room.

| | | Stnd. |
|---|---|---|
| Sample Name | Friction (gF) | Dev. |
| PA5-DMSA32-PA5 - Top Sheet | 278.568 | 10.850 |
| NiL Technology - Top Sheet | 359.724 | 14.207 |

### Fabric Care Compositions

The pre-emulsions as described above were formulated into a Heavy Duty Liquid (HDL) laundry detergent formula with the following composition:

| | % in |
|---|---|
| Material | HDL |
| HDL AE1.8S Paste ¹ | 26.83 |
| DTPA 50% ACTIVE ² | 0.63 |
| HDL Brightener 15 Premix³ | 3.03 |
| Monoethanolamine (MEA) | 2.26 |
| C12/14 AMINE OXIDE ⁴ | 1.69 |
| Alkoxylated polyamine HOD Base ⁵ | 1.20 |
| CAUSTIC SODA (NaOH) | 0.53 |
| Anionic Detergent Blend MVP-2 Paste ⁶ | 4.25 |
| Borax Premix for HDL ⁷ | 6.06 |
| C11.8 HLAS ⁸ | 4.19 |
| CITRIC ACID SOLUTION ⁹ | 5.34 |
| C12-18 FATTY ACID ¹⁰ | 1.42 |
| CALCIUM FORMATE | 0.84 |
| Water | 18.18 |
| Subtilisins (NFNA-HA Base)¹¹ - (54.5 mg/g) | 1.27 |
| MANNANASE(25.6 mg/g) | 0.06 |
| NATALASE (29.26 mg/g) | 0.31 |
| Polyethyleneimine Ethoxylate PE-20 (ODD-Base) ¹² | 1.89 |
| 20% Silicone Emulsion ¹³ | 20.00 |

¹ Available from Shell Chemicals, Houston, TX
² Diethylenetriaminepentaacetic acid, sodium salt
³Available from The Procter & Gamble Company, Cincinnati, OH
⁴ Available from The Procter & Gamble Company, Cincinnati, OH
⁵ Available from BASF, AG, Ludwigshafen
⁶ Available from The Procter & Gamble Company, Cincinnati, OH
⁷ Available from Univar, Cincinnati, OH
⁸ Available from Huntsman Chemicals, Salt Lake City, UT
⁹ Available from Ciba Specialty Chemicals, High Point, NC
¹⁰ Available from Enencor International, South San Francisco, CA.
¹¹Available from Genencor, Rochester, NY
¹² Available from BASF, AG, Ludwigshafen
¹³ Pre-emulsion comprising the organopolysiloxane as described herein
Ingredients were combined and mixed by conventional means as known by one of ordinary skill in the art.

### Treatment of Fabrics for Testing

A mini-washer test was used to evaluate the softness benefits of the molecules on Euro Touch terry fabrics. A 6.38 g dose of the HDL composition above was used in 2 gal of 6 GPG (GPG=hardness grains per gallon) water to treat the terry fabrics prior to testing as described below.

### Softness Test for Fabrics

After treatment in the mini-washer as described above, terry fabrics were dry and equilibrated in a controlled humidity room. Fabrics were cut into circles of 4.45 in (11.5 cm) diameter. Three plates with a total weight of 3 pounds were used to push the fabric circles through a 32 mm ring. Extraction energy was measured as the fabric was pushed through the ring. A NIL technology formulation (i.e., not comprising the inventive organopolysiloxane) was used as a control.

### Results

| Organopolysiloxane | Extraction | Stnd. |
|---|---|---|
| Sample Name | Energy | Dev. |
| PA2-DMSA31-PA2 emulsion | 59.45 | 1.18 |
| PA20-DMSA31-PA20 emulsion | 55.99 | 2.75 |
| PA5-DMSA31-PA5 emulsion | 57.58 | 1.18 |
| Nil Technology | 59.95 | 1.54 |

The embodiments disclosed and represented by the previous examples have many advantages. For example, they provide good deposition to the surface of fabric and hair. When incorporated in fabric treatment compositions, they provide anti-wrinkle benefit, softness, and anti-static benefit. When incorporated in hair conditioner compositions, they provide conditioning benefit and anti-static benefit.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An organopolysiloxane having the formula:
M_{w}DₓT_{y}Q_{z}
wherein:
M=[SiR₁R₂R₃O_{1/2}], [SiR₁R₂G₁O_{1/2}], [SiR₁G₁G₂O_{1/2}], [SiG₁G₂G₃O_{1/2}], or combinations thereof
D=[SiR₁R₂O_{2/2}], [SiR₁G₁O_{2/2}], [SiG₁G₂O_{2/2}] or combinations thereof
T=[SiR₁O_{3/2}], [SiG₁O_{3/2}] or combinations thereof
Q=[SiO_{4/2}]
w=is an integer from 1 to about (2+y+2z)
x=is an integer from about 5 to about 15,000
y=is an integer from 0 to about 98,
z=is an integer from 0 to about 98,
R₁, R₂ and R₃ are independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, C₁-C₃₂ alkylamino, and C₁-C₃₂ substituted alkylamino; and further, wherein:
At least one of the M, D, T incorporates at least one moiety G₁, G₂ or G₃ and
G₁, G₂, and G₃ are same or different moieties each of which has the formula: 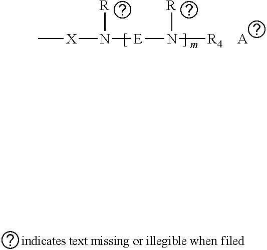
wherein:
X comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
N=a nitrogen atom;
R₄ comprises identical or different monovalent radicals from the group: H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl;
E comprises a divalent radical selected from the group consisting of C₁-C₃₂ alkylene, C₁-C₃₂ substituted alkylene, C₅-C₃₂ or C₆-C₃₂ arylene, C₅-C₃₂ or C₆-C₃₂ substituted arylene, C₆-C₃₂ arylalkylene, C₆-C₃₂ substituted arylalkylene, C₁-C₃₂ alkoxy, C₁-C₃₂ substituted alkoxy, C₁-C₃₂ alkyleneamino, C₁-C₃₂ substituted alkyleneamino, ring-opened epoxide and ring-opened glycidyl;
m=is an integer from about 2 to about 100,
n=1 or 2
when at least one of G₁, G₂, G₃ is positively charged, A^{k-} is a suitable charge balancing anion or anions such that the total charge, k, of the charge-balancing anion or anions is equal to and opposite from the net charge on the moiety G₁, G₂ or G₃, and wherein k≦m+1 for each moiety G.

2. The organopolysiloxane of claim 1 wherein w is an integer from about 2 to about 50.

3. The organopolysiloxane of claim 1 wherein x is an integer from about 10 to about 4,000, or from
about 40 to about 2,000.

4. The organopolysiloxane of claim 1 wherein w is 2 and wherein x is an integer from about 20 to about 1,000 and y and z are 0.

5. The organopolysiloxane of claim 1 wherein X comprises a divalent radical comprising from 2 to 12 carbon atoms, and each said divalent radical is independently selected from the group consisting of —(CH₂)ₚ— wherein p is an integer from 2 to 12.

6. The organopolysiloxane of claim 1 wherein A^{k-} is selected from the group consisting of Cl—, Br—, I—, methylsulfate, toluene sulfonate, carboxylate, phosphate and combinations thereof.

7. The organopolysiloxane of claim 1 wherein E are different radicals, or wherein at least one E radical is an ethylene radical, or wherein at least one E radical comprises more than 3 carbon atoms.

8. The organopolysiloxane of claim 1 wherein R₄ are different radicals, or wherein at least one R₄ is a methyl radical.

9. The organopolysiloxane of claim 1 wherein for at least one G₁, G₂ or G₃, m is an integer from 2 to about 50, or from 2 to about 25, or from 2 to about 10.

10. The organopolysiloxane of claim 1 wherein for at least one G₁, G₂ or G₃, k is an integer from 0 to about 201, or from 2 to about 50.

11. A composition comprising an organopolysiloxane according to claim 1, wherein said composition is a consumer product for treating fabric, paper, non-wovens, hair, body, or hard surfaces.

12. The composition of claim 11, wherein said composition is an aqueous composition comprising a hydrophobic benefit agent, in which the hydrophobic benefit agent is selected from the group consisting of a silicone, a vinyl polymer, a polyether, a material comprising a hydrocarbon wax, a hydrocarbon liquid, a fluid sugar polyester, a fluid sugar polyether, and mixtures thereof.

13. The composition of claim 12 wherein:
a) said silicone having a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons;
b) said vinyl polymer having a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons;
c) said polyether having a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons.

14. The composition of claim 12 wherein:
a) said silicone comprising an organosilicone;
b) said vinyl polymer is selected from group consisting of
(i) hydrogenated or unhydrogenated polyisoprene;
(ii) hydrogenated or unhydrogenated polyisoprene comprising one or more monomers selected from the group consisting of styrene, acrylonitrile, and acrylates;
(iii) hydrogenated or unhydrogenated polyisobutylene;
(iv) hydrogenated or unhydrogenated polyisobutylene comprising one or more monomers selected from the group consisting of styrene, acrylonitrile, and acrylates;
(v) hydrogenated or unhydrogenated polybutadiene;
(vi) hydrogenated or unhydrogenated polybutadiene comprising one or more monomers selected from the group consisting of styrene, acrylonitrile, and acrylates;
(vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
(viii) acrylate polymer;
(ix) methacrylate polymer;
(x) acrylate copolymers comprising at least two or at least three different acrylate and/or methacrylate monomers;
c) said polyether comprising a material selected from the group consisting of ethylene oxide, propylene oxide, butylene oxide and mixtures thereof.

15. The composition of claim 14 wherein:
a) said silicone comprises a material selected from the group consisting of a polydimethylsiloxane, an aminosilicone, a cationic silicone, a silicone polyether, a cyclic silicone, a silicone resin, a fluorinated silicone and mixtures thereof;
b) said vinyl polymer comprises a material selected from the group consisting of isoprene-isobutylene copolymer, carboxylated acrylonitrile butadiene copolymer, styrene-isoprene copolymer,styrene-butadiene block copolymers, and mixtures thereof;
c) said polyether comprises a material selected from the group consisting of polyethylene oxide, polypropylene oxide, poly alkyl oxirane, and mixtures thereof;
d) said material comprising a hydrocarbon wax comprises a material selected from petrolatum, microcrystalline wax, paraffin wax, Beeswax, Chinese wax, Lanolin, Spermaceti, Bayberry wax, Myrica faya, Candelilla wax, Carnauba wax, Copernica cerifera, Castor wax, Esparto wax, Japan wax, Jojoba oil, Simmondsia chinensis, Ouricury wax, Syagrus coronata. Rice bran wax, Soy wax, Ceresin waxes, Montan wax, Ozocerite, Peat waxes, Polyethylene waxes, Fischer-Tropsch waxes, amide substituted waxes, polymerized a-olefins, and mixtures thereof;
e) said hydrocarbon liquid comprises a material selected from the group consisting of mineral oil, non-crystalline polymerized a-olefins, and mixtures thereof.

16. The composition of claim 15 wherein:
a) said polydimethyl siloxane has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
b) said aminosilicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
c) said cationic silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
d) said silicone polyether has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
e) said cyclic silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
f) said silicone resin has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise;
g) said fluorinated silicone has a viscosity from about 200 centipoise to about 300,000 centipoise; from about 500 centipoise to about 200,000 centipoise; from about 750 centipoise to about 50,000 centipoise; or from about 1000 centipoise to about 10000 centipoise.

17. A composition according to claim 12 further comprising at least one cleansing agent.

18. A composition according to claim 17 wherein said at least one cleansing agent comprises at least one anionic surfactant.

19. A composition according to claim 18 wherein the at least one benefit agent and the organopolysiloxane are pre-mixed prior to compounding into said composition.

20. A method of manufacturing the organopolysiloxane according to claim 1 comprising combining amino silicone, diamine and dihalide under inert atmosphere and reacting at a temperature from about ambient to about 150° C.
